(19) United States
(12) Patent Application Publication
(10) Pub. No.: US 2013/0075207 A1
(43) Pub. Date: Mar. 28, 2013

(54) BRAKE ROTOR AND METHOD FOR MAKING SAME

(71) Applicant: Rodney Don BRUNTZ, Valley Center, KS (US)

(72) Inventor: Rodney Don BRUNTZ, Valley Center, KS (US)

(21) Appl. No.: 13/240,116

(22) Filed: Sep. 22, 2011

(51) Int. Cl. F16D 65/12; B23P 15/00

(52) U.S. Cl. 188/218 XL; 29/428

(57) ABSTRACT

A brake rotor and a method for manufacturing the same are provided. The brake rotor includes first and second spaced apart annular plates, a plurality of radially disposed ribs extending therebetween and at least one heat sink having fins located between the plates for dissipating heat from the rotor. The plates may be formed separately from one another in a casting process. In one embodiment, the plates and ribs are foil led of cast iron and the ribs protrude from the inner surfaces of the plates. The ribs of one plate generally correspond to the ribs of the other plate so that the ribs mate up when the plates are assembled. Heat sinks, which may be machined from aluminum, each include a base having relatively thin fins extending therefrom. The heat sinks are assembled between the plates and in contact with inner surfaces of the plates.

### CROSS-REFERENCE TO RELATED APPLICATIONS

None.

### BACKGROUND OF THE INVENTION

Brake rotors are well known in the art and have been used in connection with braking systems on a variety of machinery including drilling machinery, oil field workover rigs, servicing rigs and other large industrial machinery. In recent years, large internally-finned, air-cooled brake rotors have been applied to oil field servicing rigs and other large industrial equipment. These brake rotors can, for example, be 30 to 60 inches in diameter and are often several inches thick. Internal fins provide each rotor with additional surface area to enhance the dissipation of heat generated by the friction of the braking process, which is created when brake pads are applied against the rotor.

Typically, these large brake rotors are constructed utilizing a casting process. The majority of brake rotors manufactured today are cast in a single piece, with the entire rotor, including the internal fins, being a unitary structure made of a uniform material. A mold core made of sand and clay is used to create the internal fins between the two solid outer plates of the rotor. However, this process is not without shortcomings. The sand and clay core that is used to create the internal fins has a diameter approximately equal to the overall diameter of the rotor (e.g., 30 to 60 inches) and is extremely fragile due to the voids within the core for creating the internal fins. The fragile nature of the core leads to an extremely high production failure rate (e.g., 80-90% failure rate). This high failure rate results in high production costs because several cores must be manufactured in order to produce one core that is acceptable for use.

Furthermore, the process of casting an internally-finned rotor with a sand and clay core limits the thinness of the internal fins to approximately ⅜ inch or thicker because the core cannot support its own weight, and in turn collapses, when designed to produce relatively thinner internal fins. Further yet, the entire rotors, including their internal fins, are typically made of cast iron because that material is relatively resistant to wear. However, cast iron is not the most suitable material for dissipating heat due to its thermal conductivity value.

Thus, a need exists for an internally-finned brake rotor that is capable of being produced using a method which does require an internal mold core for molding the rotor's internal fins. A need also exists for a brake rotor having external plates made of a material that is resistant to wear and internal fins made of a material having a relatively high thermal conductivity value thereby enabling the fins to efficiently dissipate heat contained within the brake rotor. A need further exists for a method for manufacturing an internally-finned brake rotor that does not require an internal mold core for molding the rotor's internal fins. Finally, a need exists for a method for manufacturing an internally-finned brake rotor capable of resulting in internal fins having a relatively thin thickness.

### SUMMARY OF THE INVENTION

The present invention involves the provision of a brake rotor including first and second spaced apart annular plates, a plurality of radially disposed ribs extending therebetween and at least one heat sink having fins located between the plates for dissipating heat from the rotor. The plates may be formed separately from one another in a casting process. Alternatively, the plates may be formed as a single piece along with the ribs extending therebetween. In one embodiment, the plates and ribs are formed of cast iron and the ribs protrude from the inner surfaces of the plates. The ribs of one plate generally correspond to the ribs of the other plate so that the ribs mate up when the plates are assembled. The ribs may define passages therebetween adapted for accommodating the heat sinks. The distal ends of the ribs and the outer surfaces of the plates are machined so that the plates will uniformly mate together and have outer surfaces (i.e., braking surfaces) that are true and generally perpendicular to the axle or shaft to which the rotor is mounted.

The heat sinks each include a base having relatively thin fins extending therefrom. The fins define channels therebetween. In one embodiment, the fins are machined from a billet of aluminum material. The heat sinks are in contact with the inner surfaces of the plates such the fins can dissipate heat from the plates. The fins of the heat sinks are adapted for dissipating more heat as compared to those of existing rotors because the fins can be made thinner since they are not cast between the plates using a sand and clay mold core. Additionally, since the heat sinks are formed separately from the plates, the heat sinks, including the fins, can be made of a material, like aluminum, having a higher thermal conductivity value than the cast iron plates.

The present invention also involves the provision of a method for manufacturing a brake rotor. In one embodiment, the plates are formed in a casting process and then the outer braking surfaces and ribs thereof are machined. Holes are drilled and tapped into the plates for fastening heat sinks thereto. Additional holes are drilled into the plates for fastening the plates to one another. Heat sinks may be machined from a billet of material. Holes are also drilled through the heat sinks for attaching the heat sinks to the plates. The heat sinks are then attached to the inner surfaces of the plates using fasteners. Finally, the plates are assemble together using fasteners such that the ribs and heats sinks are located therebetween. Optionally, the outer braking surfaces of the plates may be machined after the plates are assembled. This manufacturing process additionally results in a substantial cost savings as compared to previous processes which form the rotor's internal fins with a sand and clay mold core having a high production failure rate.

Other and further objects of the invention, together with the features of novelty appurtenant thereto, will appear in the course of the following description.

### DESCRIPTION OF THE SEVERAL VIEWS OF THE DRAWING

In the accompanying drawing, which forms a part of the specification and is to be read in conjunction therewith in which like reference numerals are used to indicate like or similar parts in the various views:

FIG. 1 is a side perspective view of a brake rotor assembly in accordance with one embodiment of the present invention;

FIG. 2 is a cross-section view of the brake rotor assembly shown in FIG. 1 taken generally along line 2-2 in the direction of the arrows;

FIG. 3 is an exploded view of a brake rotor assembly in accordance with one embodiment of the present invention;

FIG. 4 is a side perspective view illustrating the inner side of an annular plate of a brake rotor in accordance with one embodiment of the present invention;

FIG. 5 is a side view illustrating the inner side of an annular plate of a brake rotor in accordance with one embodiment of the present invention;

FIG. 6 is a cross-section view of the annular plate shown in FIG. 5 taken generally along line 6-6 in the direction of the arrows;

FIG. 7 is a side perspective view of a heat sink of a brake rotor in accordance with one embodiment of the present invention;

FIG. 8 is a side view of a heat sink of a brake rotor in accordance with one embodiment of the present invention; and

FIG. 9 is a cross-section view of the heat sink shown in FIG. 8 taken generally along line 9-9 in the direction of the arrows.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

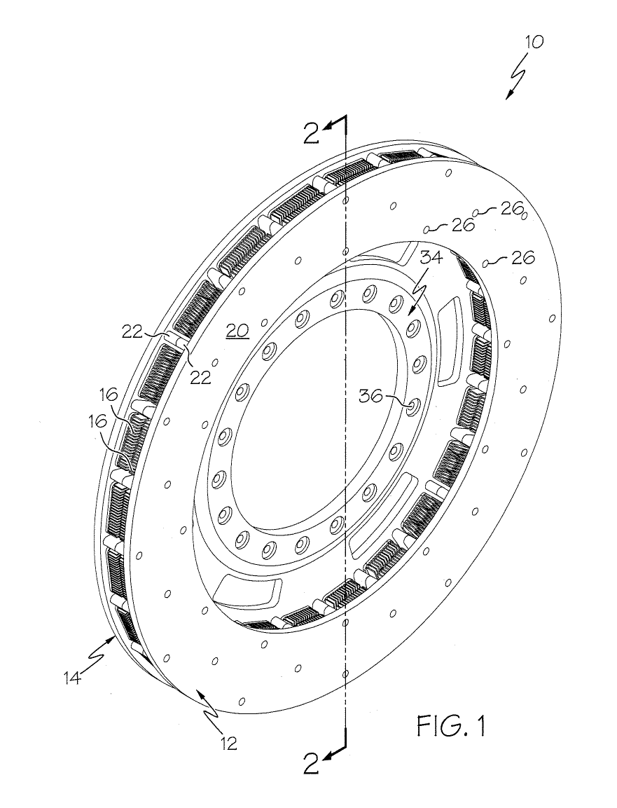

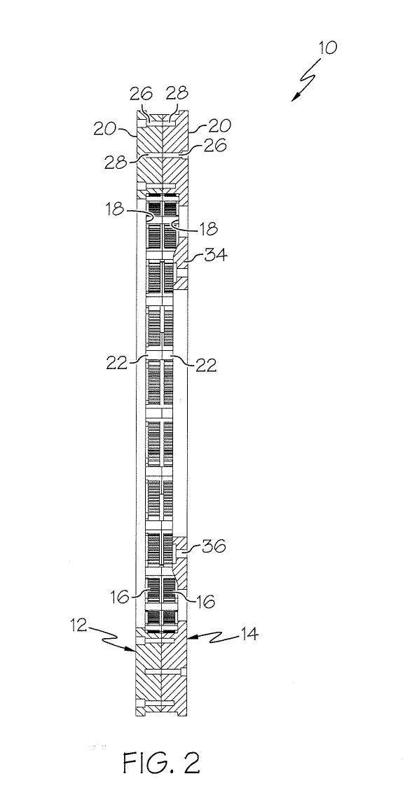

FIGS. 1 and 2 illustrate a brake rotor 10 according to one embodiment of the present invention. As shown, the brake rotor 10 is an assembly that generally includes two separately formed annular plates 12 and 14 and a plurality of heat sinks 16 disposed therebetween. The brake rotor 10 may be adapted for use in braking systems in a variety of machinery and vehicles, including drilling machinery, oil field servicing rigs, workover rigs, industrial machinery, locomotives, automobiles, trucks, construction equipment, aircraft and the like. While some embodiments of the rotor 10 may have diameters of 30 inches to 60 inches or larger, other embodiments have smaller diameters, depending upon the application in which the rotor is used.

As shown, the rotor's first and second plates 12 and 14 are nearly identical to one another. Either one or both of the plates 12 and 14 may include a hub portion 34 for mounting the rotor 10 to an axle or shaft. When the rotor 10 is mounted to an axle or shaft, brake pads and calipers or other friction linings may be set into place in order to engage the rotor 10 in a manner suitable for stopping or slowing the axle or shaft to which the rotor 10 is attached. The pads or linings are set in place to engage the exposed outer braking surfaces 20 of the rotor plates 12 and 14.

The plates 12 and 14 may be formed of cast iron, low carbon steel, steel alloy or any other suitable material now known or hereafter developed. While in a preferred embodiment the plates 12 and 14 are formed in a casting process, it is also understood that the plates may be machined from a solid billet of material. The plates 12 and 14 each have inner and outer surfaces 18 and 20. If the plates 12 and 14 are cast, the outer braking surface 20 may be machined after the plates 12 and 14 are cast in order to provide a braking surface that is true and generally perpendicular to the axle or shaft on which the rotor 10 is mounted.

While not depicted in the figures, the plates 12 and 14 may additionally include venting holes defined therethrough. The number of venting holes in each plate 12 and 14 may be of any number as long as the physical integrity of the corresponding plate 12 and 14 is not affected so that the rotor 10 can still effectively withstand the stresses arising from a braking event.

When assembled, the plates are spaced apart from one another, as best depicted in FIG. 1. Either one or both of the plates 12 and 14 may include a plurality of radially disposed ribs 22 protruding from the plate's inner surface 18 adapted for maintaining space between the inner surfaces 18 of the two plates 12 and 14. The ribs 22 may be cast or machined as a single unitary structure with the other portions of each plate 12 and 14 (i.e., disk-like portion, center hub, etc.).

As shown, in FIGS. 1-3, both plates 12 and 14 include ribs 22. In such an embodiment, the size, number and alignment of the ribs 22 of one plate 12 may correspond to the size, number and alignment of the ribs 22 of the other plate 14. The ribs 22 of one plate 12 have distal surfaces 24 adapted for mating with the distal surfaces 24 of the ribs 22 of the other plate 14. Where the plates 12 and 14 and ribs 22 are cast, the distal surfaces 24 of the ribs 22 may be machined after casting so that the two plates 12 and 14 uniformly mate together. In an alternative embodiment, only one of the plates 12 and 14 includes ribs 22. In such a case, the ribs 22 of one plate 12 or 14 mate against the inner surface 18 of the other plate 14 or 12 when the two plates 12 and 14 are assembled.

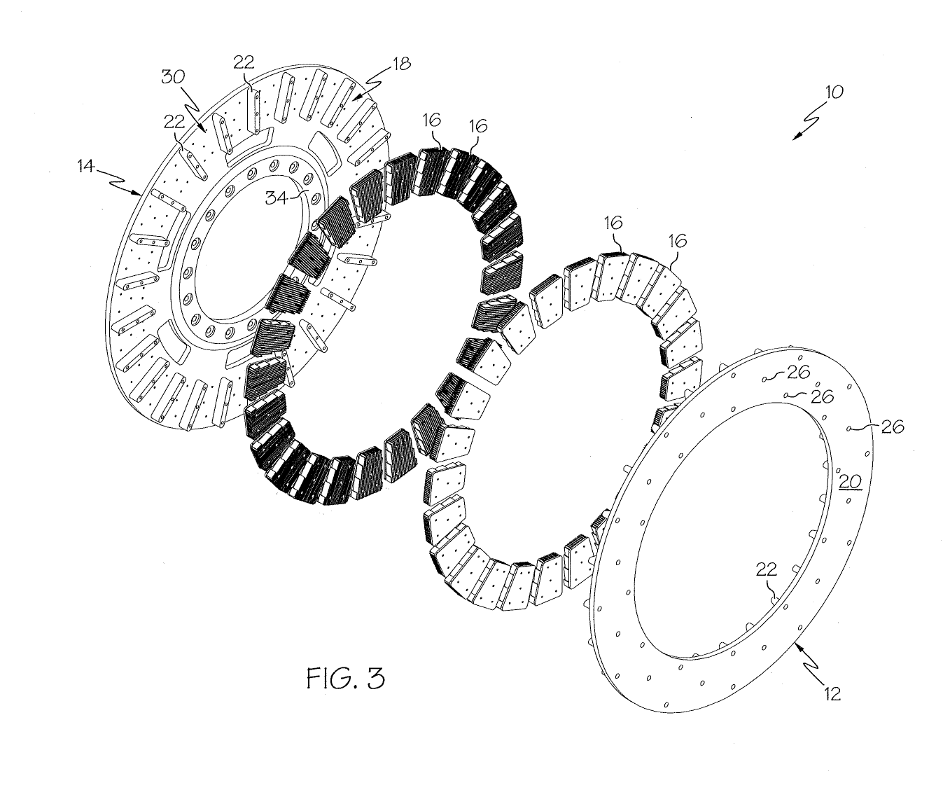

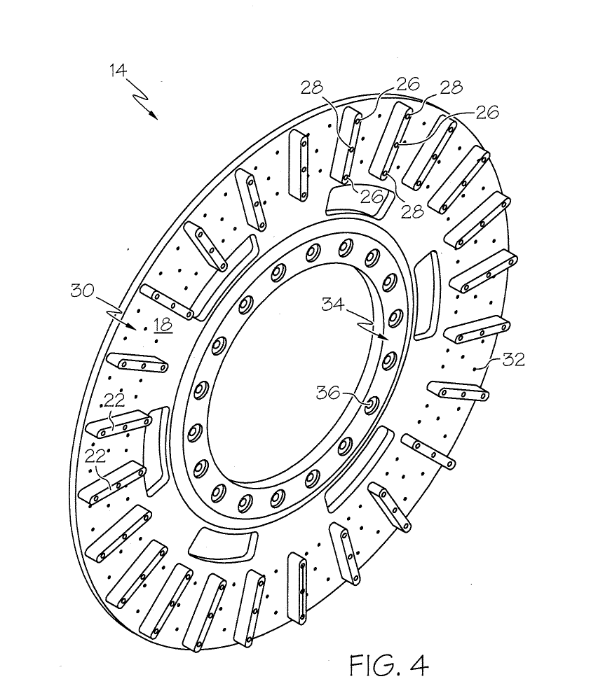

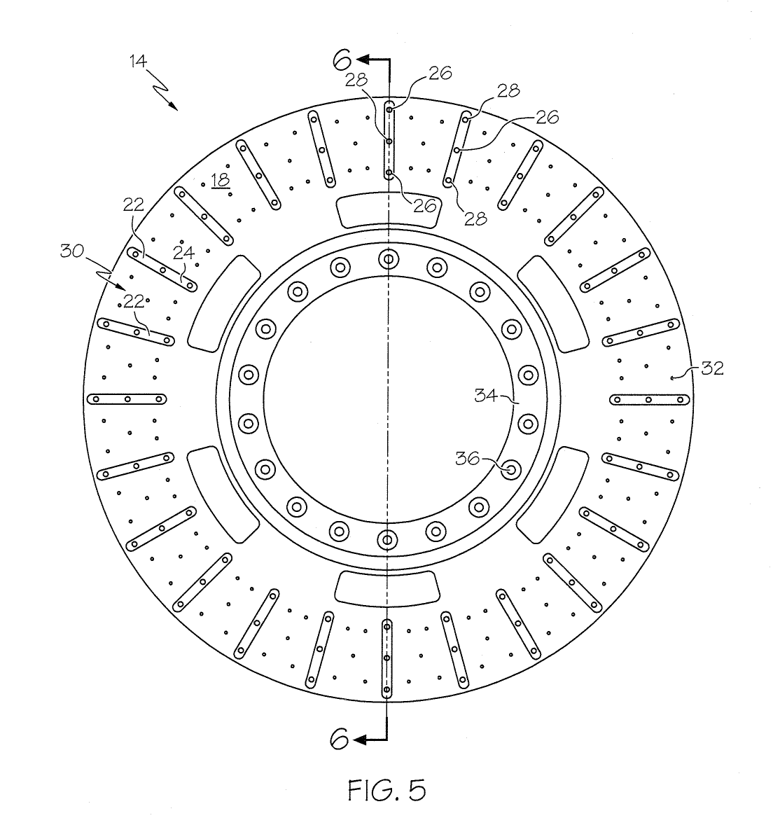

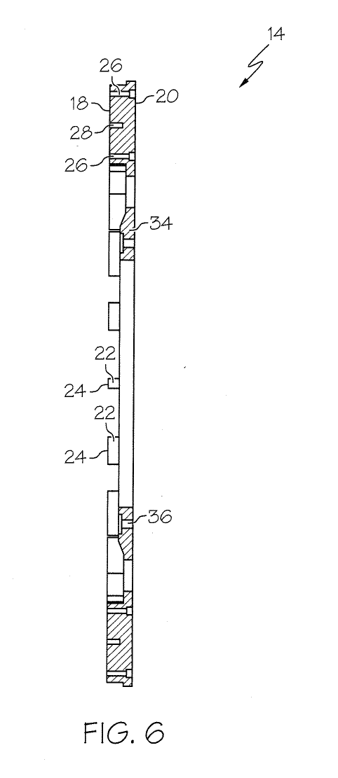

As illustrated in FIGS. 3 and 4, voids or passages 30 are defined between the ribs 22. The passages 30 may be configured for accommodating heat sinks 16 therein as shown in FIG. 1.

At least one heat sink 16 is attached to the inner surface 18 of one of the plates 12 and 14. In the embodiment illustrated in FIGS. 1-3, a plurality of generally trapezoidal-shaped heat sinks 18 are attached to the inner surfaces 18 of both plates 12 and 14. In another embodiment the individual heat sinks 16 are formed into a single heat sink with portions extending into the passages 30 of the plates 12 and 14. The heat sinks 16 may be machined from a billet and formed of any suitable material including but not limited to aluminum, copper, low carbon steel, steel alloy or any other suitable material now known or hereafter developed. Preferably, the heat sinks 16 are formed of a material having a relatively high thermal conductivity value. In one embodiment, the rotor plates 12 and 14 are constructed of material that is relatively resistant to wear, such as cast iron, while the heat sinks 16 are constructed of a material having a relatively high thermal conductivity value, such as aluminum. This dual metallic design enables the rotor 10 to be resistant to wear, yet have improved heat dissipation characteristics.

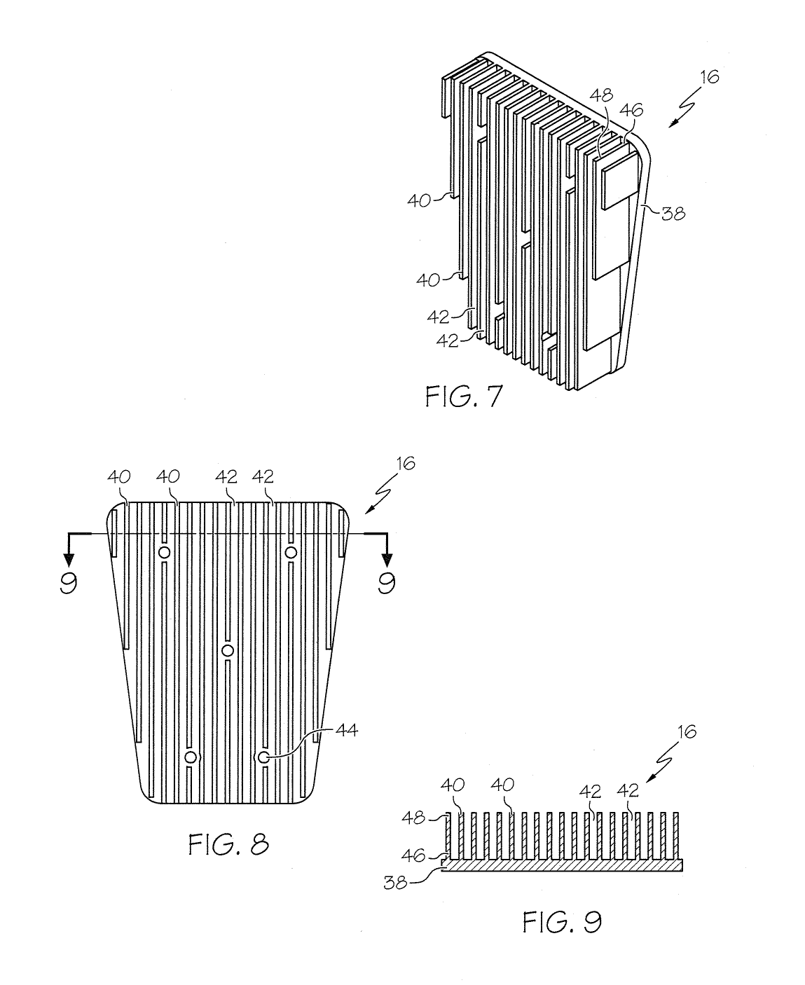

As best shown in FIGS. 7-9, each heat sink 16 includes a base 38 with a plurality of fins 40 extending therefrom providing surface area for dissipating heat from the rotor assembly 10. Small slots or channels 42 are defined between the fins 40. In one embodiment, the fins are approximately 0.1 inch thick and the channels 42 therebetween are approximately 0.1 inch thick. In another embodiment, the fins may be tapered from a base end 46 that is approximately 0.09 inch thick to a distal end 48 that is approximately 0.06 inch thick and the channels therebetween may have an average thickness of between approximately 0.15 and 0.2 inch thick. This provides a relatively large amount of surface area in a little amount of volume. As compared to existing rotors where the internal fins are cast using a sand and clay core and are approximately ⅜ inch or thicker, the heat sink 16 of the present invention provides several times more surface area, thereby providing greater ability to dissipate heat from the rotor 10. It will be understood that the fins 40 and channels 42 may have thicknesses that are greater or lesser than 0.1 inch and further that the fins and channels 42 need not both be of the same thickness. While the heat sink 16 depicted in the figures is of a straight fin configuration, the heat sink 16 may be of any other suitable configuration, including but not limited to, a pin fin configuration.

As compared to existing brake rotors where the internal fins are cast using a sand and clay core and are formed of the same material as the remainder of the rotor, the heat sinks 16 of the present invention (a) provide the rotor 10 with a substantial increase in surface area for dissipating heat since they can be constructed to have fins 40 and channels 42 and (b) are made of a material having a substantially higher thermal conductivity value as compared to the remainder of the rotor 10 thereby further enhancing heat dissipation.

As set forth above, the first plate 12, second plate 14 and heat sinks 16 may all be formed as individual pieces and then fastened together to form the rotor assembly 10. As illustrated in the figures, the bases 38 of the heat sinks 16 have a plurality of holes 44 defined therethrough. In one embodiment, the holes 44 are drilled through the heat sinks 16. Corresponding holes 32 are formed into the plates 12 and 14. The holes 32 may be drilled into the plates 12 and 14 after the plates 12 and 14 have been cast. The holes 32 are tapped so as to include screw threads. The heat sinks 16 may be attached to the plates 12 and 14 using a plurality of fasteners (not shown). The fasteners may be threaded fasteners, such as an Allen bolts or other suitable fasteners. Alternative to fasteners, the heat sinks 16 may be attached to the plates 12 and 14 using any attachment means now known or hereafter developed or may be clamped therebetween.

Once the heat sinks 16 are attached to the plates 12 and 14, the plates 12 and 14 may be secured together. Due to the size of the plates 12 and 14 and the nature of the casting process in which they may be formed, the plates 12 and 14 may initially be out of balance, meaning that one end of each plate 12 and 14 may be heavier than the other end. In order to mitigate or eliminate any balancing issues, the two plates 12 and 14 may be assembled such that they are 180 degrees offset from one another, meaning that the heavier end of one plate 12 or 14 is aligned with the lighter end of the other plate 14 or 12, and vice versa, when the plates 12 and 14 are secured together.

In one embodiment, the plates 12 and 14 are secured together with fasteners. As depicted in the figures, each plate 12 and 14 has countersunk holes 26 extending entirely through the rib 22 and disk portion thereof. Where one plate 12 has a countersunk hole 26 extending entirely therethrough, the other plate 14 includes a corresponding threaded hole 28 extending at least partially through the rib 22 portion thereof.

The holes 26 are countersunk so that the head of the fastener lies beneath the outer braking surface 20 of the plate 12 and 14. Generally, the fasteners are made of a material softer than that of the plates 12 and 14 so that the fasteners do not inscribe or etch groves into the brake pads as the plates 12 and 14 wear thin. Alternative to fasteners, the plates 12 and 14 may be connected using any attachment means now known or hereafter developed.

While the figures illustrate that the plates 12 and 14 are formed as two separated pieces, it will be appreciated that the plates 12 and 14 may be cast as a single piece. In such an embodiment, the heat sinks 16 are placed and attached within the passages 30 formed by the ribs 22 after the plate structure is cast.

Turning now to the method for manufacturing the rotor 10, the rotor's first and second plates 12 and 14 may be formed in a casting process. Alternatively, the plates 12 and 14 may be machined from a billet of material. Upon exiting the casting mold, the cast plates 12 and 14 can be machined. The outer braking surface 20 and hub 34 may be machined in order to provide a braking surface 20 that is true and generally perpendicular to the axle or shaft on which the rotor 10 is mounted. Additionally, the distal surfaces 24 of the ribs 22 may be machined so that the two plates 12 and 14 uniformly mate together. Holes 26, 28 and 36 are drilled into the plates, some or all of which may be tapped in order to cut threads therein.

The heat sinks 16 may be machined from a billet of material. Alternatively, the heat sinks 16 may be formed in a casting process. Channels 42 may be machined into the heat sinks to form fins 40. In an alternative embodiment, the two plates 12 and 14 are formed as separate pieces, either by machining or casting, and the fins of the heat sinks 16 are machined therein.

Upon the formation of the plates 12 and 14 and heat sinks 16, the heat sinks 16 are attached to the inner surfaces 18 of the plates 12 and 14. Next, plates 12 and 14 are assembled together such that the ribs 22 and heat sinks 16 are located therebetween. The plates 12 and 14 can be assembled using fasteners, such as Allen bolts. Optionally, the outer braking surfaces 20 of the plates 12 and 14 may be machined after the plates 12 and 14 are assembled.

From the foregoing, it will be seen that this invention is one well adapted to attain all the ends and objects hereinabove set forth together with other advantages which are obvious and which are inherent to the structure. It will be understood that certain features and sub combinations are of utility and may be employed without reference to other features and sub combinations. This is contemplated by and is within the scope of the claims. Since many possible embodiments of the invention may be made without departing from the scope thereof, it is also to be understood that all matters herein set forth or shown in the accompanying drawings are to be interpreted as illustrative and not limiting.

The constructions described above and illustrated in the drawings are presented by way of example only and are not intended to limit the concepts and principles of the present invention. Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A brake rotor assembly comprising:
first and second spaced apart annular plates, each said plate including an inner surface and an outer braking surface;
a plurality of radially disposed ribs protruding from said inner surface of at least one of said plates, said ribs adapted for maintaining space between said inner surfaces of said plates when said plates are assembled; and
at least one heat sink attached to said inner surface of at least one of said plates, said heat sink including a plurality of fins for dissipating heat from the assembly.

2. The brake rotor assembly of claim 1, wherein said ribs protrude from said inner surfaces of both said first and second plates.

3. The brake rotor assembly of claim 2, wherein said ribs protruding from said first plate correspond to said ribs protruding from said second plate.

4. The brake rotor assembly of claim 3, wherein said ribs protruding from said first plate include distal surfaces adapted for mating with distal surfaces of said ribs protruding from said second plate when said first and second plates are assembled.

5. The brake rotor assembly of claim 1, wherein said ribs define flow passages therebetween for accommodating said heat sinks.

6. The brake rotor assembly of claim 1 comprising a plurality of said heat sinks, a portion of which are attached to the inner surface of said first plate and a portion of which are attached to the inner surface of said second plate.

7. The brake rotor assembly of claim 6 further comprising a plurality of first fasteners for attaching said heat sinks to said plates and a plurality of second fasteners for coupling said plates to one another to form said brake rotor assembly.

8. The brake rotor assembly of claim 1, wherein said plates and ribs are cast iron and said heat sink is aluminum.

9. The brake rotor assembly of claim 1, wherein said heat sink fins are approximately 0.1 inch thick and define channels approximately 0.15 inch thick therebetween.

10. The brake rotor assembly of claim 1, wherein said first plate, second plate and heat sink are formed as individual pieces and bolted together to form said brake rotor assembly.

11. The brake rotor assembly of claim 10, wherein said ribs are cast in a unitary construction with said first plate.

12. The brake rotor assembly of claim 11, wherein distal surfaces of said ribs and the outer braking surfaces of said first and second plates are machined after casting.

13. The brake rotor assembly of claim 1, wherein one of said plates includes a hub portion with holes for mounting said brake rotor assembly to a shaft.

14. A brake rotor assembly comprising:
first and second spaced apart annular cast iron plates, each said plate including an inner surface and an outer braking surface;
a plurality of radially disposed ribs protruding from said inner surface of said first plate having machined distal surfaces and a plurality of corresponding radially disposed ribs protruding from said inner surface of said second plate having machined distal surfaces, wherein said ribs protruding from said first plate are adapted for mating with said ribs protruding from said second plate for maintaining space between said inner surfaces of said plates when said plates are assembled; and
a plurality of aluminum heat sinks, a portion of which are attached to said inner surface of said first plate between said ribs protruding therefrom and a portion of which are attached to said inner surface of said second plate between said ribs protruding therefrom, wherein said heat sinks each include a plurality of fins for dissipating heat from the assembly.

15. A method of manufacturing a brake rotor, wherein said brake rotor comprises two annular disks and at least one heat sink therebetween, said method comprising the steps of:
forming a first annular plate having generally flat first and second surfaces and a first set of radially disposed ribs protruding from said first surface;
forming a second annular plate having generally flat first and second surfaces;
forming a heat sink having fins defining passages therebetween;
attaching said heat sink to the first surface of at least one of said first and second plates; and
assembling said first and second plates such that said ribs and said heat sink are located between said plates.

16. The method of claim 15, wherein said first and second plates are cast iron and formed as individual pieces and said heat sink is aluminum.

17. The method of claim 15, wherein said second plate includes a second set of radially disposed ribs protruding from its said first surface corresponding to said first set of ribs, said ribs of said first and second sets of ribs having distal ends.

18. The method of claim 17 further comprising the step of machining said distal ends of said ribs such that said corresponding ribs of first and second sets of ribs are adapted for mating with one another.
